(19) United States
(12) Patent Application Publication
(10) Pub. No.: US 2009/0058504 A1
(43) Pub. Date: Mar. 5, 2009

(54) SELF-POWERED VOLTAGE ISLANDS ON AN INTEGRATED CIRCUIT

(75) Inventors: Kenneth J. Goodnow, Essex Junction, VT (US); Stephen G. Shuma, Underhill, VT (US); Peter A. Twombly, Shelburne, VT (US)

Correspondence Address: HOFFMAN WARNICK LLC, 75 STATE ST, 14TH FLOOR, ALBANY, NY, 12207, US

(73) Assignee: INTERNATIONAL BUSINESS MACHINES CORPORATION, Armonk, NY (US)

(21) Appl. No.: 11/849,463

(22) Filed: Sep. 4, 2007

(51) Int. Cl. G05F 1/10

(52) U.S. Cl. 327/530

(57) ABSTRACT

The present disclosure is directed to self-powered voltage islands on an integrated circuit. A structure in accordance with an embodiment includes: an integrated circuit including a power source; a voltage island; and an on-board power source provided on the voltage island for powering the voltage island independently of the power source of the integrated circuit.

### BACKGROUND

The disclosure generally relates to integrated circuits, and more specifically relates to self-powered voltage islands on an integrated circuit. Further, the disclosure relates to the design structure on which a self-powered voltage island and/or an integrated circuit including at least one self-powered voltage island resides.

Power consumption is an important factor that must be considered in the design of integrated circuits (ICs). One technique that is used to lower power consumption is to lower the voltage to the IC. However, this can degrade performance because transistors perform faster at the higher end of the voltage range. To this extent, there is a battle between lowering the voltage to reduce power consumption and raising the voltage to increase performance.

One solution to this problem is to isolate sections of the IC design that require higher performance, and raise the voltage just on those sections, which are usually referred to as “voltage islands.” In this manner, an IC designer can isolate (electrically) those sections of an IC design that operate at a higher voltage than other circuitry on the IC. An example of an IC 10 including a plurality of voltage islands 12 is depicted in FIG. 1. Power to the voltage islands 12 on the IC 10 can be provided, for example, by the global power or a shared power bus 14. This is done to minimize the number of separate voltages on the IC 10.

Voltage islands can also be used to allow selective powering on/off of different processing sections of the IC (e.g., when the processing is not required or its operation might interfere with other portions of the IC). Such interference can include, for example, noise generation or power consumption. Typically, a voltage island is isolated from the remainder of an IC by turning off the power to the voltage island. Unfortunately, this also results in the termination of processing on the voltage island.

### SUMMARY

The disclosure relates to self-powered voltage islands on an integrated circuit. Further, the disclosure relates to the design structure on which a self-powered voltage island and/or an integrated circuit including at least one self-powered voltage island resides.

A first aspect is directed to a structure, comprising: an integrated circuit including a power source; a voltage island; and an on-board power source provided on the voltage island for powering the voltage island independently of the power source of the integrated circuit.

A second aspect is directed to an integrated circuit, comprising: a power source; a voltage island; and an on-board power source provided on the voltage island for powering the voltage island independently of the power source of the integrated circuit.

A third aspect is directed to a design structure embodied in a machine readable medium used in a design flow process, the design structure comprising a circuit, the circuit comprising: a power source; a voltage island; and an on-board power source provided on the voltage island for powering the voltage island independently of the power source of the integrated circuit.

The illustrative aspects of the present disclosure are designed to solve the problems herein described and other problems not discussed.

### BRIEF DESCRIPTION OF THE DRAWINGS

These and other features will be more readily understood from the following detailed description taken in conjunction with the accompanying drawings.

FIG. 1 depicts an integrated circuit including a plurality of voltage islands.

FIG. 2 depicts an illustrative self-powered voltage island in accordance with an embodiment of the disclosure.

FIG. 3 depicts an illustrative self-powered voltage island in accordance with another embodiment of the disclosure.

FIG. 4 depicts an illustrative voltage switch in accordance with an embodiment of the present invention.

FIG. 5 depicts an illustrative integrated circuit including a plurality of voltage islands and a self-powered voltage island in accordance with embodiment(s) of the disclosure.

FIG. 6 depicts a block diagram of a general-purpose computer system which can be used to implement the self-powered voltage islands, IC, and circuit design structure described herein.

FIG. 7 depicts a block diagram of an example design flow.

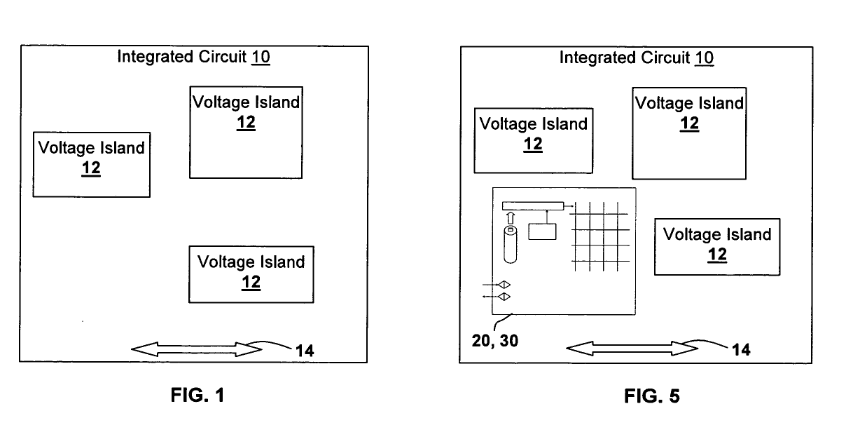

The drawings are merely schematic representations, not intended to portray specific parameters of the present disclosure. The drawings are intended to depict only typical embodiments of the disclosure, and therefore should not be considered as limiting the scope of the disclosure. In the drawings, like numbering represents like elements.

### DETAILED DESCRIPTION

As detailed above, the disclosure relates to self-powered voltage islands on an integrated circuit (IC).

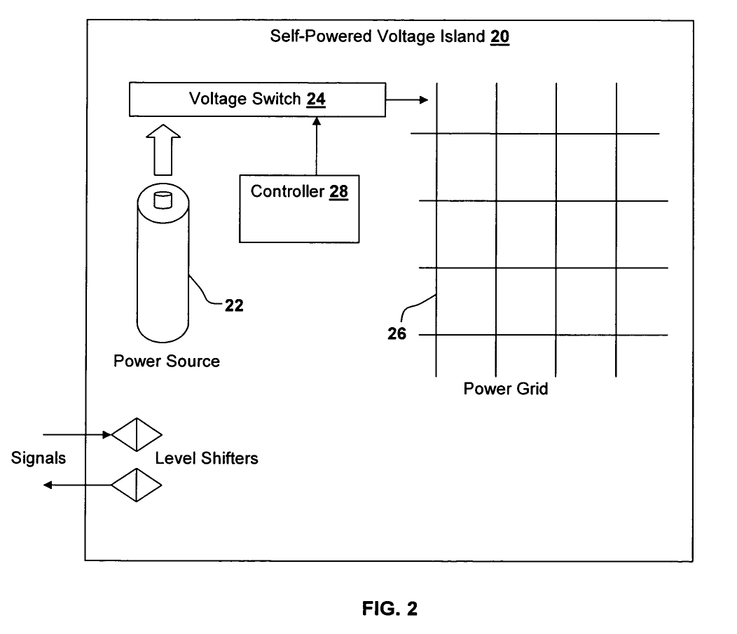

An illustrative self-powered voltage island 20 in accordance with an embodiment of the disclosure is depicted in FIG. 2. Power is provided to the voltage island 20 by an on-board power source 22. The power source 22 is independent of, and isolated from, the power source of the IC containing the voltage island 20 (e.g., independent of the IC power bus).

The power source 22 can be provided in a number of ways. For example, the power source 22 can comprise:

(a) a capacitor;
(b) a super capacitor;
(c) an environmental harvesting power circuit (e.g., a thermocouple);
(d) a solar cell;
(e) a nuclear “snap” generator (e.g., a tritium source); or
(f) a chemical battery.
Other now known or later developed power sources 22 that can be implemented on an IC can also be used to power the self-powered voltage island 20. The capacitor, super capacitor, and potentially the chemical battery may need access to the IC power bus in order to charge the power source 22 before use. However, once charged, the power source 22 powers the voltage island 20 independently of the power source of the IC containing the voltage island 20.

The power source 22 is coupled through a voltage switch 24 to the power grid 26 of the voltage island 20. The voltage switch 24, which is included but is optional, is used to selectively control the provision of power from the power source 22 to the voltage island 20. The voltage switch 24, if used, is controlled by a controller 28, which selectively actuates the voltage switch 24 to turn on/off the power to the voltage island 20 in response to a control signal (e.g., an externally generated control signal provided to the voltage island 20). In this embodiment, the controller 28 is powered by the power source 22. In other embodiments, the controller 28 can be powered by a power source external to the voltage island 20 and/or can be located external to the voltage island 20. If a voltage switch 24 is not used, the power source 22 provides a continuous source of power to the power grid 26 of the voltage island 20.

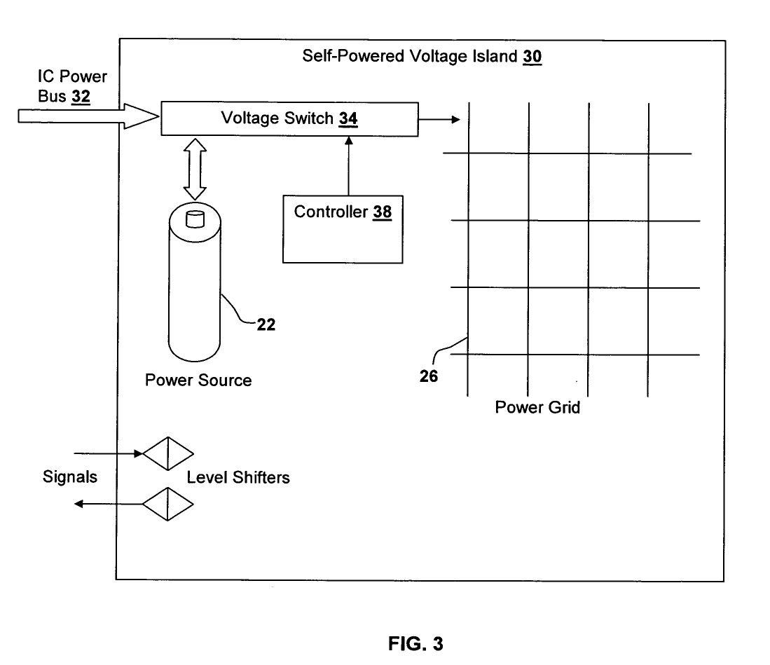

An illustrative self-powered voltage island 30 in accordance with another embodiment of the disclosure is depicted in FIG. 3. In this embodiment, power can be selectively provided to the voltage island 30 using the on-board power source 22 or the power bus 32 of the IC containing the voltage island 30. As detailed above, the power source 22 is independent of the IC power bus 32. This approach can be used, for example, to charge the power source 22 or to allow intermittent use of the power source 22 (e.g., when the voltage island 30 implements a real-time clock, critical parameter registers, etc).

The power source 22 is coupled through a voltage switch 34 to the power grid 26 of the voltage island 30. The voltage switch 34 is used to selectively control the provision of power from either the IC power bus 32 or the power source 22 to the voltage island 30.

The voltage switch 34 is controlled by a controller 38. The controller 38 selectively actuates the voltage switch 34 to provide power to the power grid 26 of the voltage island 30 from either the IC power bus 32 or the power source 22 in response to a control signal (e.g., an internally/externally generated control signal provided to the voltage island 30).

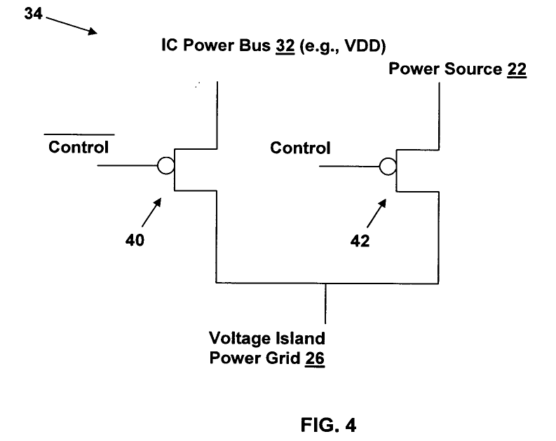

An illustrative voltage switch 34 is depicted in FIG. 4. The voltage switch 34 comprises a pair of FETs 40, 42. A signal C̅o̅n̅t̅r̅o̅l̅ is provided to the gate of FET 40, while a signal Control is provided to the gate of FET 42. When Control is HIGH, the voltage island 30 is powered by the on-board power source 22. When Control is LOW, the voltage island 30 is powered by the IC power bus 32 (e.g., VDD).

The controller 38 can be powered by the power source 22 and/or the IC power bus 32. Further, the controller 28 can be located external to the voltage island 30.

An illustrative IC 10 including a plurality of voltage islands 12 and a self-powered voltage island 20, 30 in accordance with an embodiment of the disclosure is depicted in FIG. 5. Power to the voltage islands 12 on the IC 10 can be provided, for example, by a shared IC power bus 14. Power to the self-powered voltage island 20, 30 is provided by an on-board power source 22. Power to the self-powered voltage island 30 can be selectively provided by an on-board power source 22 or the shared IC power bus 14. The IC 10 can include a plurality of self-powered voltage islands 20, 30.

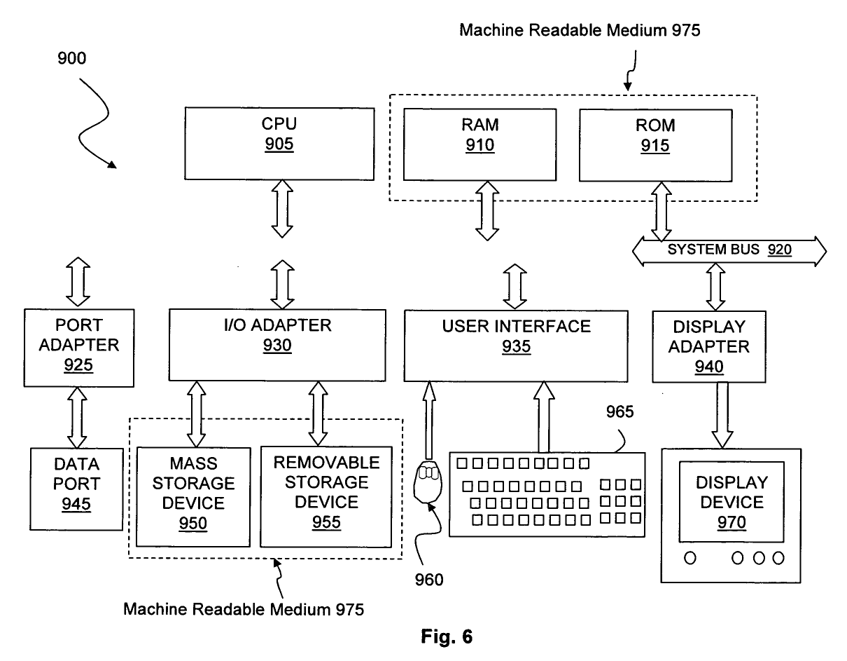

FIG. 6 depicts a block diagram of a general-purpose computer system 900 that can be used to implement the self-powered voltage islands 20, 30, IC 10, and circuit design structure described herein. The design structure may be coded as a set of instructions on removable or hard media for use by the general-purpose computer 900. The computer system 900 has at least one microprocessor or central processing unit (CPU) 905. The CPU 905 is interconnected via a system bus 920 to machine readable media 975, which includes, for example, a random access memory (RAM) 910, a read-only memory (ROM) 915, a removable and/or program storage device 955, and a mass data and/or program storage device 950. An input/output (I/O) adapter 930 connects mass storage device 950 and removable storage device 955 to system bus 920. A user interface 935 connects a keyboard 965 and a mouse 960 to the system bus 920, a port adapter 925 connects a data port 945 to the system bus 920, and a display adapter 940 connect a display device 970. The ROM 915 contains the basic operating system for computer system 900. Examples of removable data and/or program storage device 955 include magnetic media such as floppy drives, tape drives, portable flash drives, zip drives, and optical media such as CD ROM or DVD drives. Examples of mass data and/or program storage device 950 include hard disk drives and non-volatile memory such as flash memory. In addition to the keyboard 965 and mouse 960, other user input devices such as trackballs, writing tablets, pressure pads, microphones, light pens and position-sensing screen displays may be connected to user interface 935. Examples of the display device 970 include cathode-ray tubes (CRT) and liquid crystal displays (LCD).

A machine readable computer program may be created by one of skill in the art and stored in computer system 900 or a data and/or any one or more of machine readable medium 975 to simplify the practicing of this invention. In operation, information for the computer program created to run the present invention is loaded on the appropriate removable data and/or program storage device 955, fed through data port 945, or entered using keyboard 965. A user controls the program by manipulating functions performed by the computer program and providing other data inputs via any of the above mentioned data input means. The display device 970 provides a way for the user to accurately control the computer program and perform the desired tasks described herein.

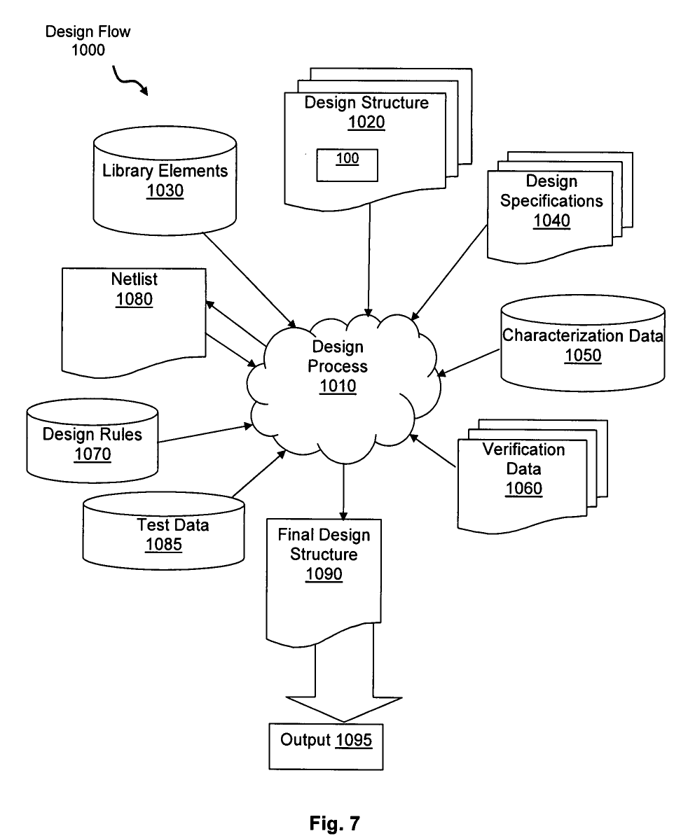

FIG. 7 depicts a block diagram of an example design flow 1000, which may vary depending on the type of IC being designed. For example, a design flow 1000 for building an application specific IC (ASIC) will differ from a design flow 1000 for designing a standard component. A design structure 1020 is an input to a design process 1010 and may come from an IP provider, a core developer, or other design company. The design structure 1020 comprises a circuit 100 (e.g., self-powered voltage islands 20, 30, IC 10, etc.) in the form of schematics or HDL, a hardware-description language, (e.g., Verilog, VHDL, C, etc.). The design structure 1020 may be on one or more of machine readable medium 975 as shown in FIG. 6. For example, the design structure 1020 may be a text file or a graphical representation of circuit 100. The design process 1010 synthesizes (or translates) the circuit 100 into a netlist 1080, where the netlist 1080 is, for example, a list of fat wires, transistors, logic gates, control circuits, I/O, models, etc., and describes the connections to other elements and circuits in an integrated circuit design and recorded on at least one machine readable medium 975.

The design process 1010 includes using a variety of inputs; for example, inputs from library elements 1030 which may house a set of commonly used elements, circuits, and devices, including models, layouts, and symbolic representations, for a given manufacturing technology (e.g., different technology nodes, 32 nm, 45 nm, 90 nm, etc.), design specifications 1040, characterization data 1050, verification data 1060, design rules 1070, and test data files 1085, which may include test patterns and other testing information. The design process 1010 further includes, for example, standard circuit design processes such as timing analysis, verification tools, design rule checkers, place and route tools, etc. One of ordinary skill in the art of integrated circuit design can appreciate the extent of possible electronic design automation tools and applications used in design process 1010 without deviating from the scope and spirit of the invention.

Ultimately, the design process 1010 translates the circuit 100, along with the rest of the integrated circuit design (if applicable), into a final design structure 1090 (e.g., information stored in a GDS storage medium). The final design structure 1090 may comprise information such as, for example, test data files, design content files, manufacturing data, layout parameters, wires, levels of metal, vias, shapes, test data, data for routing through the manufacturing line, and any other data required by a semiconductor manufacturer to produce circuit 100. The final design structure 1090 may then proceed to an output stage 1095 of design flow 1000; where output stage 1095 is, for example, where final design structure 1090: proceeds to tape-out, is released to manufacturing, is sent to another design house, or is sent back to the customer.

The foregoing description of the preferred embodiments of this disclosure has been presented for purposes of illustration and description. It is not intended to be exhaustive or to limit the disclosure to the precise form disclosed, and obviously, many modifications and variations are possible.

1. A structure, comprising:
an integrated circuit including a power source;
a voltage island; and
an on-board power source provided on the voltage island for selectively powering the voltage island independently of the power source of the integrated circuit.

2. The structure of claim 1, further comprising:
a voltage switch; and
a controller;
wherein the controller controls the voltage switch to selectively apply power from the on-board power source to the voltage island.

3. The structure of claim 1, further comprising:
a voltage switch; and
a controller;
wherein the controller controls the voltage switch to selectively apply power from the on-board power source or the power source of the integrated circuit to the voltage island.

4. The structure of claim 3, wherein the controller controls the voltage switch to charge the on-board power source by selectively applying power from the power source of the integrated circuit to the on-board power source.

5. The structure of claim 1, wherein the on-board power source is selected from the group consisting of a capacitor, a super capacitor, an environmental harvesting power circuit; a solar cell, a nuclear snap generator, and a chemical battery.

6. An integrated circuit, comprising:
a power source;
a voltage island; and
an on-board power source provided on the voltage island for selectively powering the voltage island independently of the power source of the integrated circuit.

7. The integrated circuit of claim 6, further comprising:
a voltage switch; and
a controller;
wherein the controller controls the voltage switch to selectively apply power from the on-board power source to the voltage island.

8. The integrated circuit of claim 6, further comprising:
a voltage switch; and
a controller;
wherein the controller controls the voltage switch to selectively apply power from the on-board power source or the power source of the integrated circuit to the voltage island.

9. The integrated circuit of claim 8, wherein the controller controls the voltage switch to charge the on-board power source by selectively applying power from the power source of the integrated circuit to the on-board power source.

10. The integrated circuit of claim 6, wherein the on-board power source is selected from the group consisting of a capacitor, a super capacitor, an environmental harvesting power circuit; a solar cell, a nuclear snap generator, and a chemical battery.

11. (canceled)
